(19) United States
(12) Patent Application Publication
(10) Pub. No.: US 2009/0165287 A1
(43) Pub. Date: Jul. 2, 2009

(54) MANUFACTURING METHOD FOR MAGNETIC HEAD SLIDER

(75) Inventors: Michinao NOMURA, Kawasaki (JP); Mitsuru KUBO, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/340,947

(22) Filed: Dec. 22, 2008

(30) Foreign Application Priority Data
Dec. 27, 2007 (JP) 2007-338322

(51) Int. Cl. G11B 5/127

(52) U.S. Cl. 29/603.12; 29/603.07

(57) ABSTRACT

A bar is cut from a wafer having head elements arrayed thereon along sectional surfaces parallel to each other and orthogonal to a wafer surface. One sectional surface is set as a medium opposing surface of a head slider. Polishing processing is performed on the bar, starting from a “surface corresponding to rear side” corresponding to a wafer rear surface, with a grinding surface rubbed in a transverse direction of the bar. The roughness of the “surface corresponding to rear side” of the bar is reduced. By suppressing the surface roughness in this way, a read element and write element among head elements can be obtained with high dimensional accuracy. Such a manufacturing method considerably contributes to reduction of a dimension error of a head element, in particular, a write element.

### BACKGROUND

1. Field

The present technique relates to a manufacturing method for a magnetic head slider incorporated into a magnetic storage medium drive such as a hard disk drive (HDD), for example.

2. Description of the Related Art

A manufacturing method for a magnetic head slider has been well known. Upon manufacturing the magnetic head slider, head elements are arrayed in arbitrary numbers of rows and columns on a wafer surface. After that, bars are cut from a wafer along surfaces parallel to each other and orthogonal to the wafer surface in section. In this way, each cut bar includes elements arrayed in prescribed numbers of rows and columns. One sectional surface is set as a medium opposing surface of the head slider.

The sectional surface set as the medium opposing surface is subjected to polishing processing, or lapping processing. A read signal is read from a head element in a predetermined position upon the lapping processing. A polishing amount for the lapping processing is adjusted based on the read signal. As a result, the dimensions of the read element in the head elements can be adapted to a prescribed value.

Upon the lapping processing, each bar is bonded to a processing jig. At the time of bonding the bar, the bar is held on a bonding surface of the processing jig at the other sectional surface. In this case, it is necessary to precisely keep the sectional surface set as the medium opposing surface in parallel to the bonding surface. To keep the surfaces parallel to each other in this way, a positioning jig is used. The positioning jig defines a planer surface orthogonal to the bonding surface. One surface of the bar corresponding to the rear side of the wafer is pressed against the planer surface of the positioning jig.

Prior to the lapping processing, one surface of the bar corresponding to the rear side of the wafer is subjected to grinding processing. The bar is adjusted to a prescribed size of a head slider through the grinding processing. The sectional surface set as the medium opposing surface cannot be parallel to the bonding surface with high accuracy until the grinding processing is performed with high machining accuracy. If an accuracy of parallelism is lowered, a polishing amount of a write element among the head element does not match that of a read element. As a result, the write element involves a dimension error.

It is an object of the present technique to provide a manufacturing method for a magnetic head slider, which can considerably contribute to reduction of a dimension error of a head element.

### SUMMARY

According to an aspect of an embodiment, the present technique provides a manufacturing method for a magnetic head slider. The method includes a step of cutting a bar from a wafer having head elements arrayed thereon along sectional surfaces parallel to each other and orthogonal to a wafer surface, with one sectional surface being set as a medium opposing surface of the head slider, and a step of performing grinding processing for grinding a surface-corresponding-to-rear-side corresponding to a wafer rear surface by a grinding surface rubbed in a transverse direction of the bar.

### BRIEF DESCRIPTION OF THE DRAWINGS

FIG. 1 is a schematic plan view showing the inner structure of an embodiment of a storage medium drive, or a hard disk drive (HDD);

FIG. 2 is a schematic enlarged perspective view showing a floating head slider of the embodiment;

FIG. 3 is a schematic front view showing an electromagnetic conversion element as viewed from a medium opposing surface;

FIG. 4 is a sectional view taken along the line 4-4 of FIG. 3;

FIG. 5 is a schematic perspective view showing a wafer having an electromagnetic conversion element group formed thereon;

FIG. 6 is a schematic enlarged perspective view showing a bar cut from a wafer;

FIG. 7 is a schematic enlarged perspective view showing a bar cut from a bar;

FIG. 8 is a schematic enlarged perspective view showing a floating head slider cut from a bar;

FIG. 9 is a perspective view showing a temporary fixture;

FIG. 10 is a schematic perspective view showing a temporary fixture that supports a bar;

FIG. 11 is a schematic side view showing a process for measuring a posture of a “surface corresponding to front side” of each bar;

FIG. 12 is a perspective view showing a supporting jig;

FIG. 13 is a perspective view showing a guide jig attached to a supporting jig;

FIG. 14 is a perspective view showing a temporary fixture attached to a guide jig on a supporting jig;

FIG. 15 is a partial sectional side view schematically showing a process for adjusting a posture of a temporary fixture;

FIG. 16 is a partial sectional side view schematically showing a process for cooling an adhesive applied onto a holding surface;

FIG. 17 is a partial sectional side view schematically showing a radiator fin attached to a guide jig;

FIG. 18 is a perspective view showing a supporting jig that supports a bar bonded onto a holding surface;

FIG. 19 is a partial sectional side view schematically showing a process for adjusting a posture of a supporting jig on a grinding stage;

FIG. 20 is a schematic perspective view showing grinding processing applied to a bar on a supporting jig;

FIG. 21 is a perspective view showing a bar removed from a supporting jig;

FIG. 22 is a perspective view showing a bar bonded to a processing jig for lapping processing;

FIG. 23 is a schematic side view showing lapping processing performed on a bar;

FIG. 24 is a graph showing a result of examining grinding processing of the embodiment; and

FIG. 25 is a graph showing a result of examining grinding processing of Comparative Example.

### DESCRIPTION OF THE PREFERRED EMBODIMENTS

Hereinafter, an embodiment of the present technique will be described with reference to the accompanying drawings.

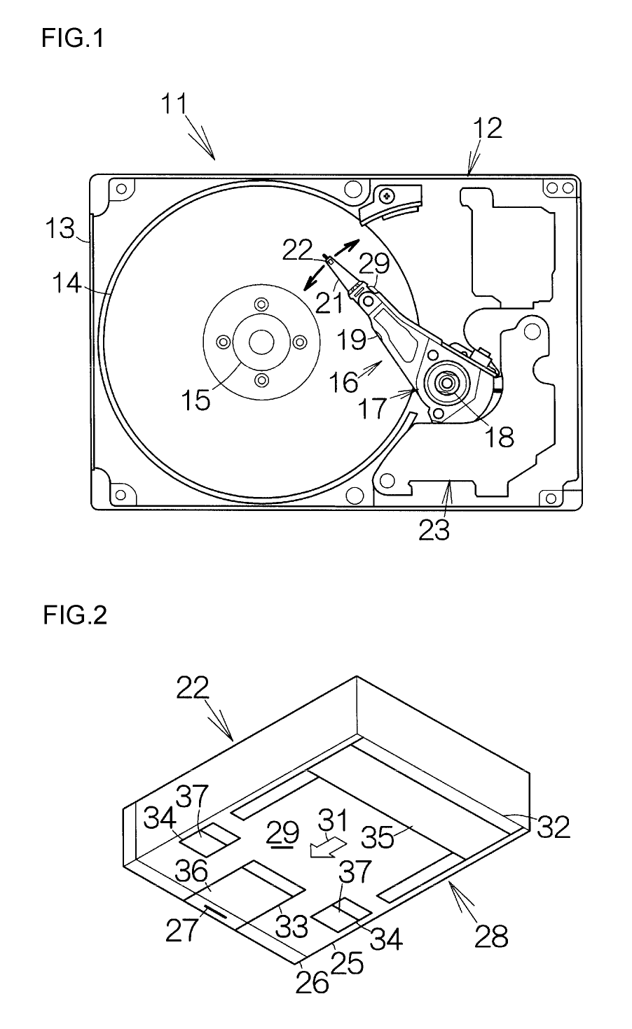

FIG. 1 schematically shows the inner structure of an embodiment of a storage medium drive, or a hard disk drive (HDD) 11. The HDD 11 includes a housing, or a housing 12. The housing 12 is composed of a box-like base 13 and a cover (not shown). The base 13 defines, for example, a flat rectangular inner space, or storage space. The base 13 may be made of a metal material such as aluminum through molding, for example. The cover is held to the edge of an opening of the base 13. The storage space is sealed between the cover and the base 13. The cover may be made up of one plate material through pressing, for example.

The storage space accommodates one or more magnetic disks 14 as a storage medium. The magnetic disk 14 is attached to a driving shaft of a spindle motor 15. The spindle motor 15 can rotate the magnetic disk 14 at a high speed, for example, 3600 rpm, 4200 rpm, 5400 rpm, 7200 rpm, or 10000 rpm, 15000 rpm. In this example, the magnetic disk 14 is a vertical magnetic recording disk, for example. In other words, a magnetization easy axis of a recording magnetic film on the magnetic disk 14 is set to extend in a vertical direction to the surface of the magnetic disk 14.

The storage space further accommodates a carriage 16. The carriage 16 is provided with a carriage block 17. The carriage block 17 is rotatably coupled with a spindle 18 extending in a vertical direction. In the carriage block 17, plural carriage arms 19 extend from the spindle 18 in a horizontal direction. The carriage block 17 may be formed of aluminum through extrusion molding, for example.

A head suspension 21 is attached to the tip end of each carriage arm 19. The head suspension 21 extends forward from the tip end of the carriage arm 19. A flexible shaft is attached to the head suspension 21. A gimbal is defined in the flexible shaft at the tip of the head suspension 21. A head slider, or a floating head slider 22 is mounted to the gimbal. The posture of the floating head slider 22 can be changed with respect to the head suspension 21 by the action of the gimbal. A magnetic head, or an electromagnetic conversion element is mounted to the floating head slider 22.

If an air current is produced on the surface of the magnetic disk 14 along with the rotation of the magnetic disk 14, a positive pressure, or a floating force and a negative pressure act on the floating head slider 22 due to the air current. The floating force and the negative pressure balance a pressing force of the head suspension 21 to thereby keep the floating head slider 22 floating with a relatively high rigidity during rotation of the magnetic disk 14.

The carriage block 17 is connected to a power source, for example, a voice coil motor (VCM) 23. The carriage block 17 can rotate about the spindle 18 by the action of the voice coil motor 23. The carriage arm 19 and the head suspension 21 can oscillate owing to the rotation of the carriage block 17. If the carriage arm 19 oscillates on the spindle 18 while the floating head slider 22 is floating, the floating head slider 22 can move along the radius of the magnetic disk 14. As a result, the electromagnetic conversion element on the floating head slider 22 can cross a data zone between the innermost recording track and the outermost recording track. In this way, a position of the electromagnetic conversion element on the floating head slider 22 is adjusted onto a target recording track.

FIG. 2 shows the floating head slider 22 of this embodiment. The floating head slider 22 includes a base member, or a slider main body 25, which is formed into a flat rectangular shape. An insulative non-magnetic film, or an element-embedded film 26 is laminated on an air outlet side of the slider main body 25. An electromagnetic conversion element 27 (head element) is embedded into the element-embedded film 26. The electromagnetic conversion element 27 is described in detail below.

The slider main body 25 is formed of, for example, a hard non-magnetic material such as Al2O-TiC (AlTiC). The element-embedded film 26 is formed of, for example, an insulative relatively-soft non-magnetic material such as Al2O3 (alumina). The slider main body 25 faces to the magnetic disk 14 on one surface, or a medium opposing surface 28. A flat base surface 29, or a reference surface is defined on the medium opposing surface 28. Along with the rotation of the magnetic disk 14, an air current 31 acts on the medium opposing surface 28 from a front end of the slider main body 25 to a rear end.

One front rail 32 is formed on the medium opposing surface 28, extending on the base surface 29 on an upstream side of the air current 31, or an air inlet side. The front rail 32 extends in a slider width direction along the air inlet end of the base surface 29. Likewise, a rear center rail 33 is formed on the medium opposing surface 28, extending on the base surface 29 on a downstream side of the air current 31, or the air outlet side. The rear center rail 33 is formed at the center in the slider width direction. The rear center rail 33 reaches the element-embedded film 26. On the medium opposing surface 28, a pair of right and left rear side rails 34, 34 is further formed. The rear side rails 34 extend on the base surface 29 along the side edge of the slider main body 25 on the air outlet side. The rear center rail 33 is formed between the rear side rails 34, 34.

Air bearing surfaces (ABSs) 35, 36, 37, and 37 are defined on top surfaces of the front rail 32, the rear center rail 33, and the rear side rails 34, 34. Air inlet ends of the air bearing surfaces 35, 36, 37, and 37 are formed into a step-like shape continuous to the top surfaces of the air bearing surfaces 35, 36, 37, and 37. If the air current 31 is applied to the medium opposing surface 28, a relatively-high positive pressure, or floating force is generated at the air bearing surfaces 35, 36, 37, and 37 due to the step-like shape. In addition, a high negative pressure is generated at the back, or the rear of the front rail 33. A floating posture of the floating head slider 22 is kept by maintaining balance between the floating force and the negative pressure. The form of the floating head slider 22 is not limited to the above one.

The electromagnetic conversion element 27 is embedded to the rear center rail 33 on the air outlet side of the air bearing surface 36. The electromagnetic conversion element 27 includes, for example, a read element and a write element. A tunnel magnetoresistance (TMR) element is used as the read element. In the TMR element, a resistance change of a tunnel junction film occurs depending on a direction of a magnetic field applied from the magnetic disk 14. Information is read from the magnetic disk 14 based on such a resistance change. A so-called magnetic monopole head is used as the write element. The magnetic monopole head generates a magnetic field by the action of a thin-film coil pattern. The magnetic field is applied to thereby write information to the magnetic disk 14. A read gap of the read element or a write gap of the write element is formed opposite to the surface of the element-embedded film 26 by the electromagnetic conversion element 27. Here, a hard protective film may be formed on the surface of the element-embedded film 26 on the air outlet side of the air bearing surface 37. This hard protective film covers the read gap or write gap exposed on the surface of the element-embedded film 26. A DLC (diamond like carbon) film may be used as the protective film.

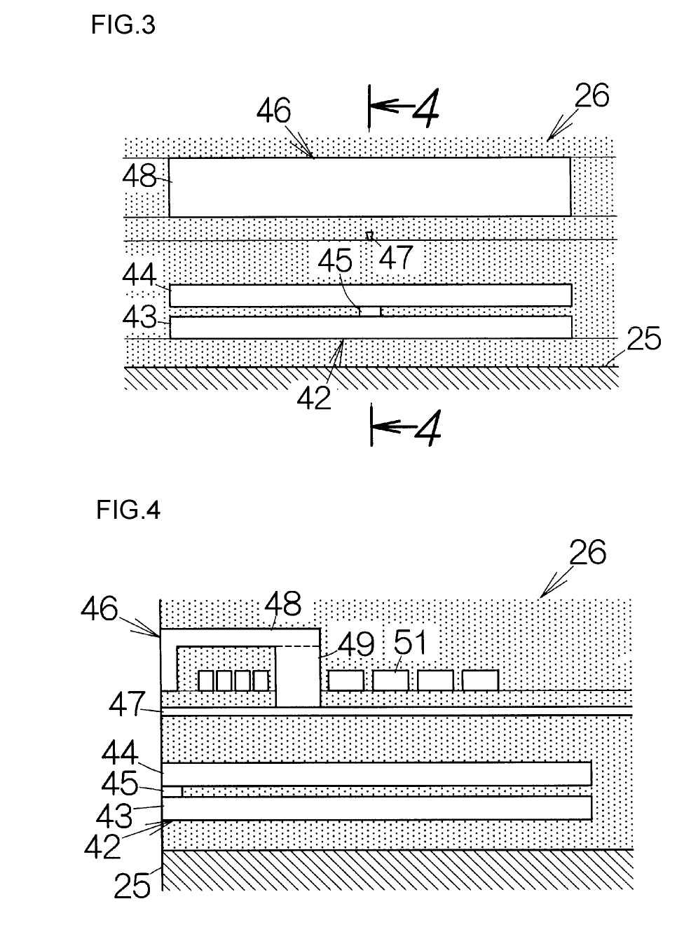

As shown in FIG. 3, in the read element 42, a pair of upper and lower conductive layers, or a lower electrode layer 43 and an upper electrode layer 44 sandwich a tunnel magnetoresistance film 45. The lower electrode layer 43 and the upper electrode layer 44 may be formed of, for example, a magnetic material such as FeN or NiFe. Thus, the lower electrode layer 43 and the upper electrode layer 44 can function as a lower shield layer and an upper shield layer. As a result, a distance between the lower electrode layer 43 and the upper electrode layer 44 influences a resolution power for magnetic recording in a recording track direction on the magnetic disk 14. A so-called CIP giant magnetoresistance (GMR) element or CPP giant magnetoresistance (GMR) element may be used as the read element 42 in place of the TMR element. As for the CIP type GMR element or CPP type GMR element, a spin valve film may be used as the magnetoresistance film.

The write element 46, or the magnetic monopole head includes a main magnetic pole 47 and a sub magnetic pole 48 exposed on the surface of the rear center rail 33. The main magnetic pole 47 and the sub magnetic pole 48 may be formed of, for example, a magnetic material such as FeN or NiFe. Referring also to FIG. 4, a rear end of the sub magnetic pole 48 is connected to the main magnetic pole 47 with a magnetic connection piece 49. A magnetic coil, or a thin-film coil pattern 51 is formed around the magnetic connection piece 49. Thus, the main magnetic pole 47, the sub magnetic coil 48, and the magnetic connection piece 49 constitute a magnetic core that passes through the center of the thin film coil pattern 51. A so-called thin film magnetic head may be used as the write element.

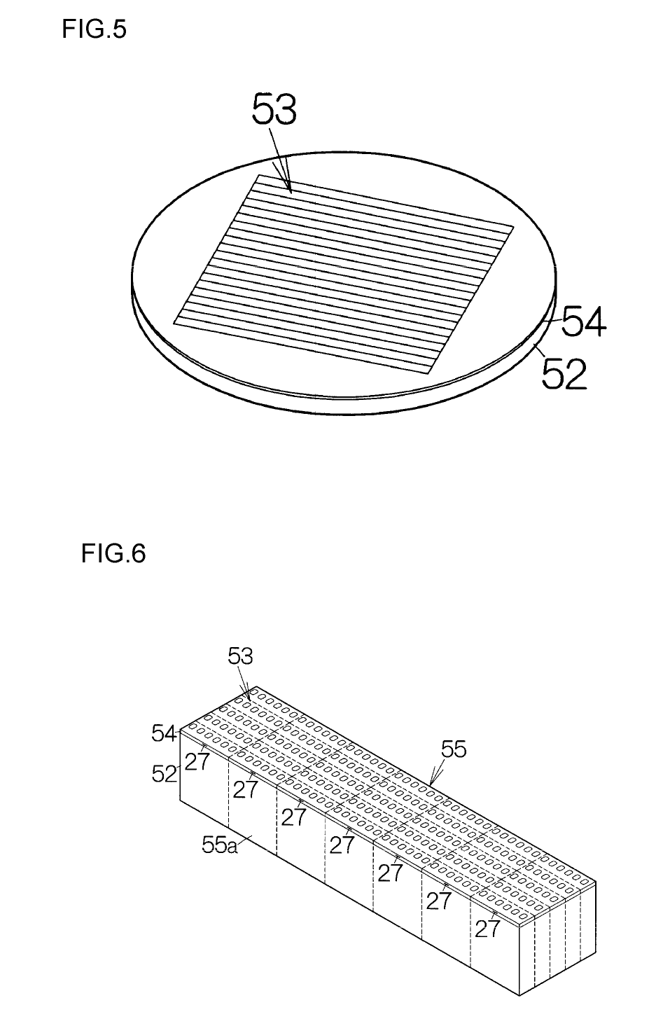

Next, how to manufacture the floating head slider 22 is described. As shown in FIG. 5, for example, an AlTiC-made wafer 52 is prepared. An electromagnetic conversion element group 53 including plural electromagnetic conversion elements 27 arrayed in arbitrary numbers of rows and columns is formed on the surface of the wafer 52. On the surface of the wafer 52, the electromagnetic conversion element group 53 is embedded to an alumina film 54. After that, as shown in FIG. 6, bars 55 are cut from the wafer 52 along sectional surfaces parallel to each other and orthogonal to the surface of the wafer 52. The cut bars each include the electromagnetic conversion elements 27 arrayed in prescribed numbers of rows and columns. One sectional surface 55a is set as the medium opposing surface 28 of the floating head slider 22.

The sectional surface 55a of the bar 55 is subjected to polishing processing, or lapping processing. As a result, the electromagnetic conversion elements 27 positioned in the front row and exposed to the surface of the sectional surface 55a are polished. At this time, a read signal is read from the electromagnetic conversion elements 27 in predetermined positions. As the electromagnetic conversion elements 27 in predetermined positions, for example, the electromagnetic conversion elements 27 positioned at both ends may be used. A polishing amount for the lapping processing is adjusted based on the read signal. As a result, the dimensions of the read element selected from the electromagnetic conversion elements 27 positioned in the front row can be adjusted to a prescribed value. The lapping processing is described in detail below.

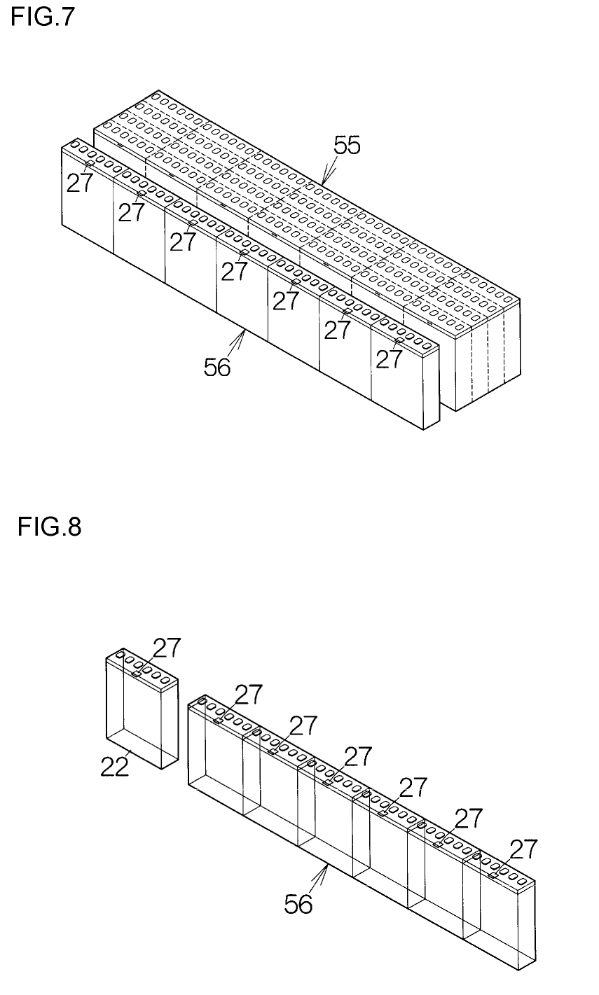

A hard carbon protective film, or diamond like carbon film is laminated on the sectional surface 55a. After that, the medium opposing surface 28 is formed in each section of the sectional surface 55a corresponding to one floating head slider 22. For example, the front rail 32, the rear center rail 33, the rear side rails 34, 34, and the air bearing surfaces 35, 36, 37, and 37 are formed through photolithography. After the formation of the medium opposing surface 28, a bar 56 including the electromagnetic conversion elements 27 positioned in the front row is cut from the bar 55 as shown in FIG. 7. Subsequently, as shown in FIG. 8, the floating head sliders 22 are cut from the bar 56.

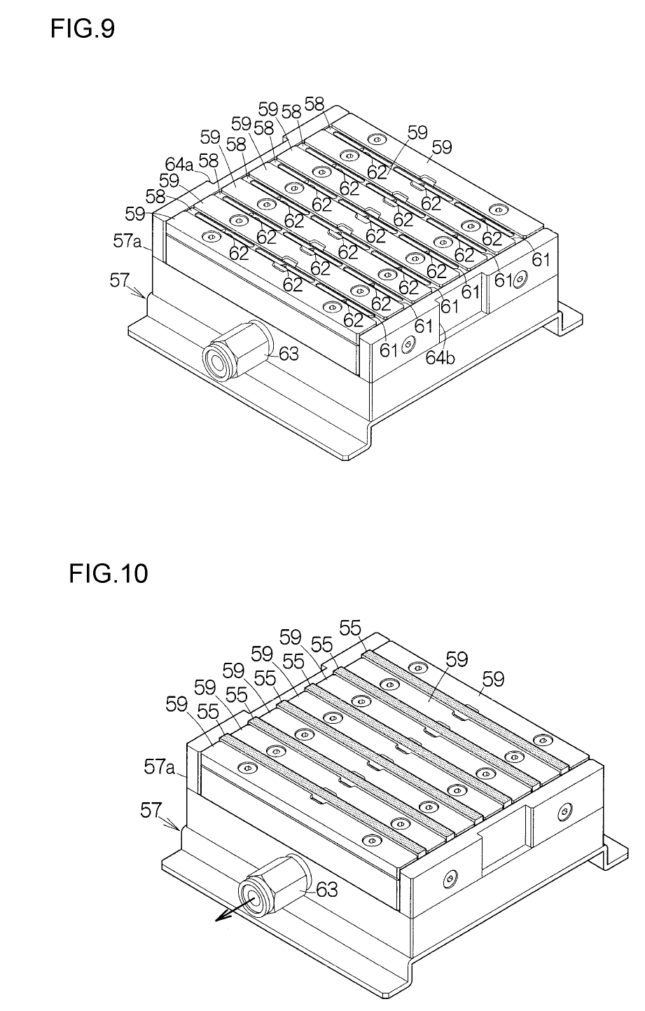

Next, the lapping processing is described in detail. First, as shown in FIG. 9, a temporary fixture 57 is prepared. The temporary fixture 57 includes a fixture main body 57a. The fixture main body 57a has flat temporary holding surfaces 58, which are partitioned from one another. The temporary holding surface 58 is defined within a virtual plane. Upon the partition, blocking members 59 are arranged between the temporary holding surfaces 58 and 58. A groove 61 is defined on each temporary holding surface 58 by the blocking member 59. The grooves 61 extend in parallel to each other. A width of the groove 61 corresponds to a distance between sectional surfaces of the bar 55. A depth of the groove 61 is set smaller than a distance between one surface of the bar 55 corresponding to the front side of the wafer 52 (hereinafter, referred to as “surface corresponding to front side”) and one surface of the bar 55 corresponding to the rear side of the wafer 52 (hereinafter, referred to as “surface corresponding to rear side”), in other words, the total thickness of the wafer 52 and the alumina film 54. In this example, the “surface corresponding to front side” corresponds to the surface of the alumina film 54.

Inlet ports 62 are defined in the temporary holding surface 58. A nipple 63 is attached to the side face of the fixture main body 57a. A hollow space of the nipple 63 is continuous to the individual inlet ports 62. A pipe of a negative pressure pump (not shown) is connected to the nipple 63, for example. If the negative pressure pump is activated, an air is sucked into the inlet ports 62.

Guide grooves 64a and 64b are defined on both sides of the fixture main body 57a, extending in a vertical direction to the above virtual plane. The guide grooves 64a and 64b define a rectangular space. The ridges of the space extend straightly along a vertical direction to a virtual plane including the temporary holding surfaces 58. The guide grooves 64a and 64b differ from each other in width. The guide grooves 64a and 64b are described below in detail.

As shown in FIG. 10, the bars 55 are inserted to the grooves 61 in a one-to-one correspondence. The “surface corresponding to rear side” of the bar 55 is fitted to the temporary holding surface 58. At this time, the negative pressure pump is activated, a negative pressure is generated at each of the inlet ports 62. The bar 55 is attracted to the temporary holding surface 58 in each groove 61. In this way, the bar 55 is temporary fixed onto the temporary holding surface 58. The “surface corresponding to front side” of the bar 55 protrudes through the surface of the blocking member 59 between the blocking members 59 and 59.

Consider the case where the number of bars 55 is smaller than that of grooves 61. In this case, the bars 55 are inserted to the grooves 61 in order from the outermost grooves 61. After all bars 55 have been inserted, a dummy bar is inserted to the remaining grooves 61. The dummy bar is designed to resemble the shape of the bar 55 except that the dummy bar has a pair of surfaces with a smaller distance than that between the “surface corresponding to front side” and “surface corresponding to rear side” of the bar 55. One surface of the dummy bar is fitted to the temporary holding surface 58. In this way, all the grooves 61 receive the bars 55 and the dummy bars. If the negative pressure pump is activated, the bars 55 and the dummy bars are attracted to the temporary holding surfaces 58 in each groove 61. As a result, the bars 55 and the dummy bars are temporarily fixed onto the temporary holding surfaces 58.

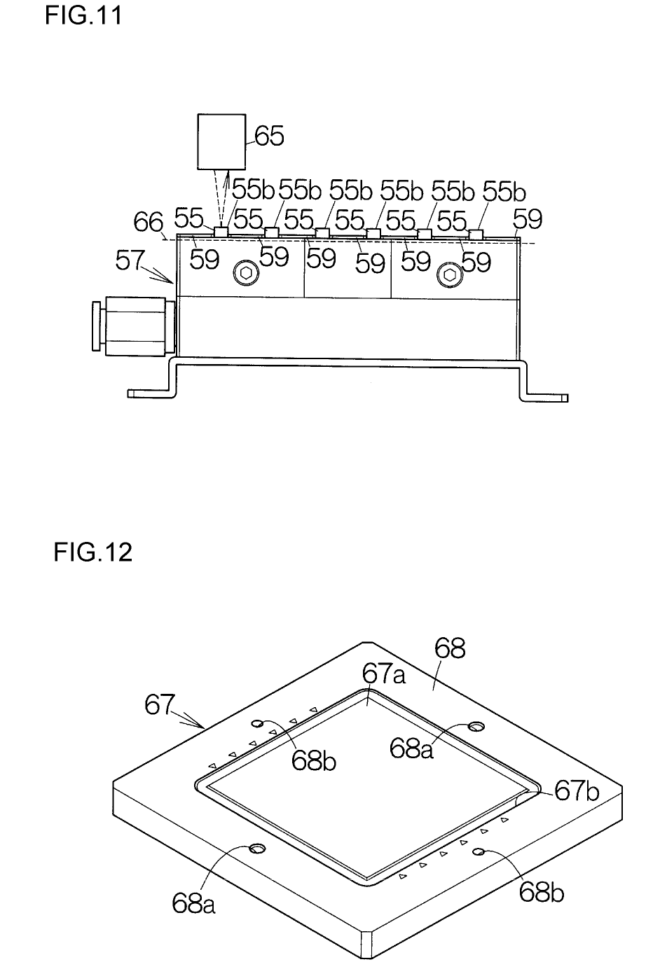

If each bar 55 is held on a corresponding temporary holding surface 58, as shown in FIG. 11, the posture of a “surface corresponding to front side” 55b of each bar is measured. In this example, the “surface corresponding to front side” 55b should be set parallel to a virtual plane 66 including the temporary holding surfaces 58. Thus, an optical axis of an autocollimator is set orthogonal to the virtual plane 66. If it is detected that the “surface corresponding to front side” 55b is inclined against the virtual plane 66 including the temporary holding surfaces 58, the bar 55 is removed from the groove 61. After the completion of cleaning the groove 61, the bar 55 is reinserted to the groove 61. A dimensional accuracy of the wafer 52 and the alumina film 54 and flatness of the temporary holding surface 58 are very high. Thus, if small dust is removed from the groove 61 at the time of cleaning, the “surface corresponding to front side” 55b can be easily set parallel to the temporary holding surfaces 58.

Next, as shown in FIG. 12, a supporting jig 67 is prepared. A flat holding surface 67a is defined in the supporting jig 67. A continuous groove 67b is formed around the flat holding surface 67a. A thermoplastic adhesive is applied to the flat holding surface 67a. Considering that the supporting jig 67 is heated, the adhesive is given fluidity. A flat bonding surface 68 is formed around the groove 67b. In the bonding surface 68, at least two guide holes 68a and two screw holes 68b are formed. The bonding surface 68 is spread within a virtual plane defined to be parallel to the holding surface 67a. Prior to a heating process of the supporting jig 67, the supporting jig 67 may be placed on a heating unit (not shown), for example. In the heating unit, an electric energy may be converted to a heat energy using heating wire.

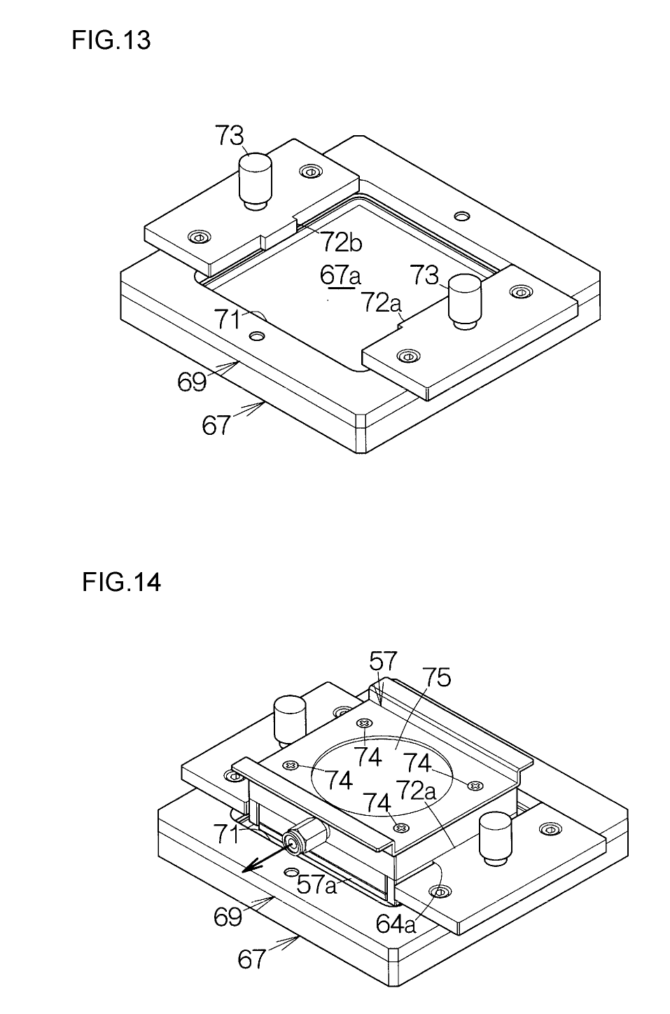

Subsequently, as shown in FIG. 13, a frame-like guide jig 69 is stacked on the supporting jig 67. At the time of stacking the guide jig 69, a positioning pin (not shown) is inserted to the guide hole 68a of the supporting jig 67. In this way, a window hole 71 of the guide jig 69 is adjusted to the holding surface 67a of the supporting jig 67. Guide pieces 72a and 72b protrude inwardly from the outer edge of the window hole 71. The guide pieces 72a and 72b have ridges extending along a vertical direction to the holding surface 67a. The guide jig 69 is fixed to the supporting jig 67. Upon the fixing the jig, a screw 73 of the guide jig 69 is screwed to the screw hole 68b of the supporting jig 67. During the attachment of the guide jig 69, the supporting jig 67 is being heated. The fluidity of the adhesive is kept.

Subsequently, as shown in FIG. 14, the temporary fixture 57 is attached to the guide jig 69 on the supporting jig 67. Upon the attachment, the temporary holding surface 58 is set opposite to the holding surface 67a. As a result, the “surface corresponding to front side” of the bar 55 (or dummy bar) on the temporary holding surface 58 faces the adhesive on the holding surface 67a. The fixture main body 57a of the temporary fixture 57 is inserted to the window hole 71 of the guide jig 69. The guide piece 72a is slipped into the guide groove 64b. In this way, the temporary fixture 57 is displaced in the vertical direction to the holding surface 67a. The “surface corresponding to front side” of the bar 55 comes into contact with the adhesive on the holding surface 67a. During the attachment of the guide jig 69, the supporting jig 67 is being heated. The fluidity of the adhesive is kept.

At this time, the posture change of the virtual plane 66 including the temporary holding surfaces 58 with respect to the fixture main body 57a is allowed in the temporary fixture 57, for example. The posture change of the virtual plane 66 is realized using four screws 74, for example. Each screw 74 has an axis extending in the vertical direction to the holding surface 67a. Each screw 74 is rotatably coupled with the fixture main body 57a in a manner of being unmovable in a vertical direction. The thread of each screw 74 is screwed to the virtual plane 66 (more specifically, a member defining the virtual plane 66). Thus, the virtual plane 66 can move vertically along the axial line of the screw 74 along with the rotation of each screw 74.

An adjustment reflective surface 75 is formed on the temporary fixture 57. The adjustment reflective surface 75 is secured in a predetermined posture with respect to the virtual plane 66 including the temporary holding surfaces 58. In this example, the adjustment reflective surface 75 is parallel to the virtual plane 66. The posture change of the virtual plane 66 causes the posture change of the adjustment reflective surface 75.

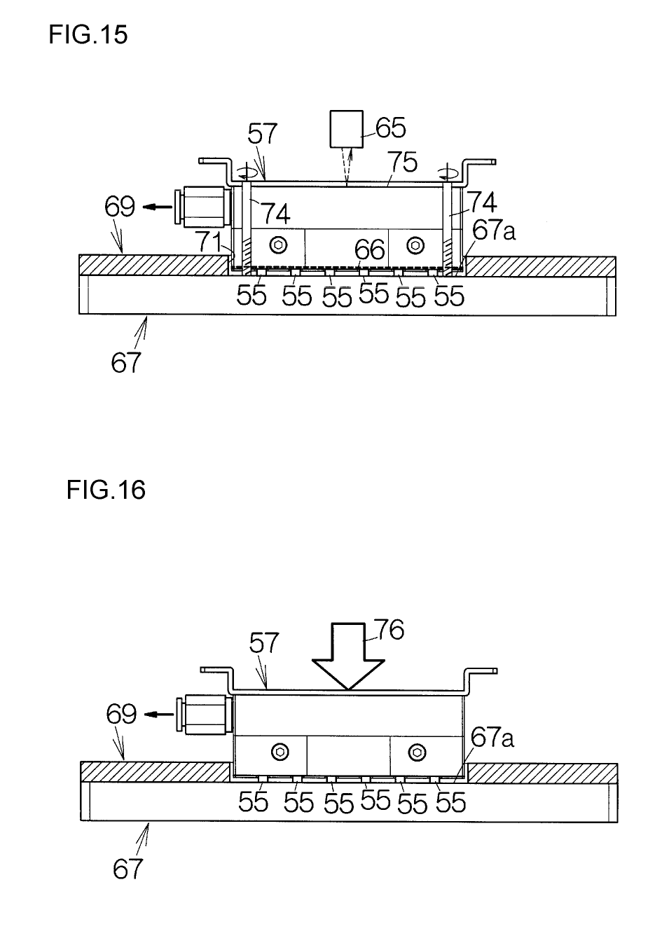

If each bar 55 comes into contact with the adhesive on the holding surface 67a, as shown in FIG. 15, the posture of the adjustment reflective surface 75 is measured. An autocollimator 65 is used for measuring the posture. In this example, the adjustment reflective surface 75 should be parallel to the virtual plane 66 including the temporary holding surfaces 58. Thus, an optical axis of the autocollimator 65 is set orthogonal to the holding surface 67a. If it is detected that the adjustment reflective surface 75, or the virtual plane 66 is inclined against the holding surface 67a, the posture of the temporary fixture 57 is adjusted through the rotation of the screws 74. In this way, the holding surface 67a and the virtual plane 66, or the temporary holding surfaces 58 are kept in parallel to each other. During such a process for setting the surfaces parallel to each other, the supporting jig 67 is being heated. The fluidity of the adhesive is kept.

Since the bars 55 are arranged at predetermined intervals, for example, if there is any contamination between a particular bar 55 and the holding surface 67a when the temporary holding surface 58 of the temporary fixture 57 is set opposite to the holding surface 67a, an angular change of the temporary holding surface 58 with respect to the holding surface 67a can be suppressed. Therefore, at the time of adjusting the posture of the temporary fixture 57, an adjustment amount can be minimized. As a result, the load of adjustment can be reduced. In addition, play between the guide pieces 72a and 72b and the guide grooves 64a and 64b can be minimized. On the other hand, considering that plural bars 55 are arranged in parallel with no interval, if there is any contamination between a particular bar 55 and the holding surface 67a, an angular change of the temporary holding surface 58 with respect to the holding surface 67a becomes large. Accordingly, an adjustment amount of the posture of the temporary fixture 57 increases.

If the holding surface 67a and the temporary holding surface 58 are kept in parallel to each other, the supporting jig 67 is cooled to promote hardening of the adhesive. At the time of cooling, as shown in FIG. 16, a pressing force 76 is applied to the temporary holding surface 58 in the temporary fixture 57. Thus, each bar 55 can fit to the adhesive. The pressing force 76 is adjusted in accordance with the number of bars 55. The displacement of the temporary fixture 57 is limited to the vertical direction to the holding surface by means of the guide pieces 72a and 72b and the guide grooves 64a and 64b, so the pressing force 76 is uniformly applied to the bars 55. A pressure unit (not shown) is used for applying the pressing force 76. In the pressure unit, for example, a pressing force is generated using an electric motor.

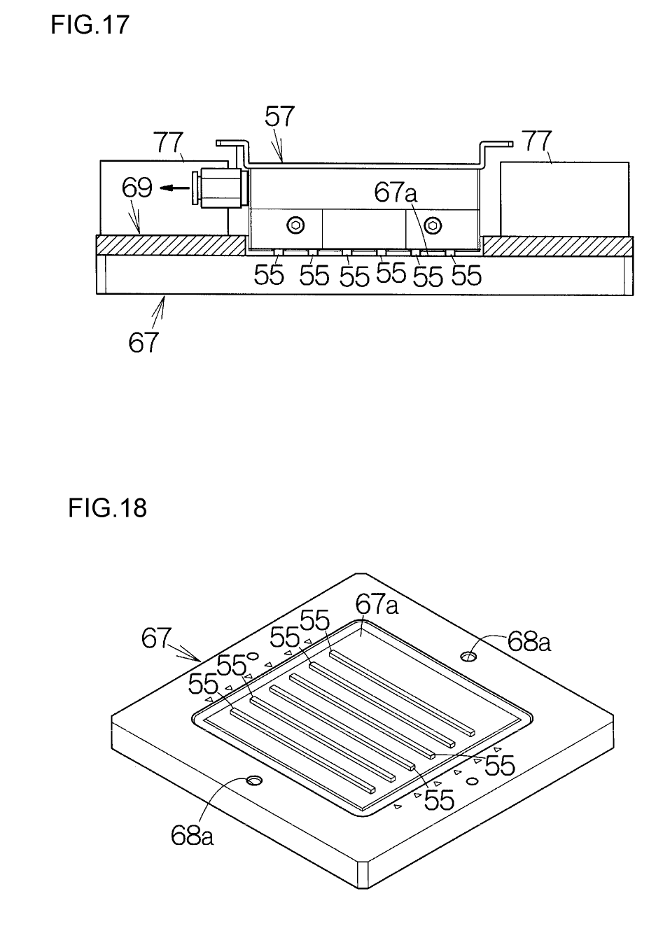

As shown in FIG. 17, for example, plural radiator fins 77 may be attached to the surface of the guide jig 69 for hardening the adhesive. The radiator fin 77 may be formed of a material having high heat conductivity, for example, copper. The radiator fin 77 can promote cooling of the temporary holding surface 58. A period necessary to harden the adhesive can be shortened. The radiator fin 77 may extend upward from the surface of the guide jig 69 along the vertical direction. The radiator fin 77 may protrude upward from the window hole 71.

If the adhesive is hardened, an operation of the negative pressure pump is stopped. Each bar 55 is released from the negative pressure generated at the inlet ports 62. Subsequently, as shown in FIG. 18, the guide jig 69 is removed from the supporting jig 67. The bars 55 are fixed to the holding surface 67a with the adhesive.

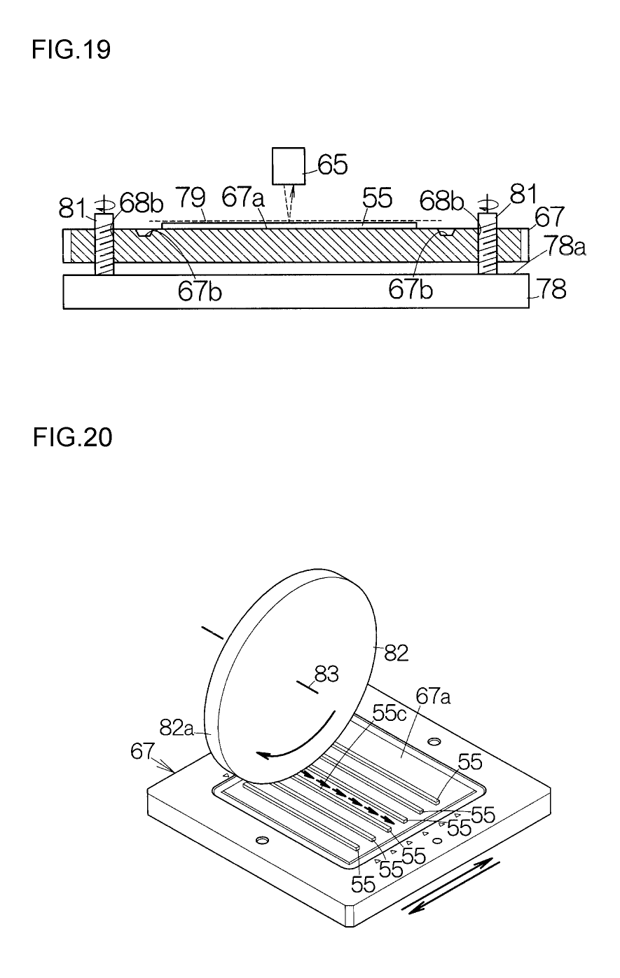

The supporting jig 67 is placed on a grinding stage of a grinding machine (not shown). Upon the placement, for example, a positioning pin (not shown) on the grinding stage is inserted to the guide hole 68a of the supporting jig 67. The positioning pin may be set in a vertical direction to a horizontal surface of the grinding stage. In this way, the position of the supporting jig 67 is adjusted on the grinding stage. At this time, as shown in FIG. 19, the inclination of the bar 55 to a horizontal surface 78a of the grinding stage 78 is measured. The autocollimator 65 is used for measuring the inclination. In this case, the inclination of the bar 55 should be corrected in a longitudinal direction. In other words, each bar needs to stay horizontal to a virtual horizontal surface 79. Accordingly, the optical axis of the autocollimator 65 is set orthogonal to the virtual horizontal surface 79 in the grinding machine. If it is detected that the bar 55 is inclined to the virtual horizontal surface 79, the inclination of the supporting jig 67, or the bar 55 is corrected through the rotation of screws 81. The screws 81 are arranged on the extension of the bar 55 in the longitudinal direction. The screws 81 have an axis extending in the vertical direction to the horizontal surface. The screw 81 is screwed to the screw hole 68b of the supporting jig 67. The tip end of the screw 81 abuts against the horizontal surface 78a of the grinding stage 78. Thus, the inclination of the supporting jig 67 is corrected through rotation of the screws 81.

After that, as shown in FIG. 20, each bar 55 is subjected to grinding processing that starts from the “surface corresponding to rear side” 55c. Upon the grinding processing, a grind wheel 82 is used. The grind wheel 82 rotates about a rotational axis 83 extending in the longitudinal direction of the bar 55. A grinding surface 82a is formed around the grind wheel 82. The grinding surface 82a is rubbed in the transverse direction of the bar 55. At the same time, the grind wheel 82 is moved in the transverse direction of the bar 55. If the grind wheel 82 is moved in the transverse direction of the bar 55 in this way, surface roughness is reduced in the transverse direction of the bar 55. Upon moving the grind wheel 82, the grind wheel 82 may move relative to the grinding stage 78, or the grinding stage 78 may move relative to the grind wheel 82. After the completion of the grinding processing of the bars 55 in the transverse direction along with the movement of the grind wheel 82, the movement direction of the grind wheel 82 is changed to the longitudinal direction of the bar 55. In this way, the grind wheel 82 is moved in the transverse direction of the bar 55 again. By repeating such movement and change in direction of the grind wheel 82, the processing for grinding each bar 55 in the longitudinal direction is completed. After the completion of the grinding processing, it is desired to lap the “surface corresponding to rear side” 55c of the bar 55 on a lapping plate prior to the removal of the bar 55.

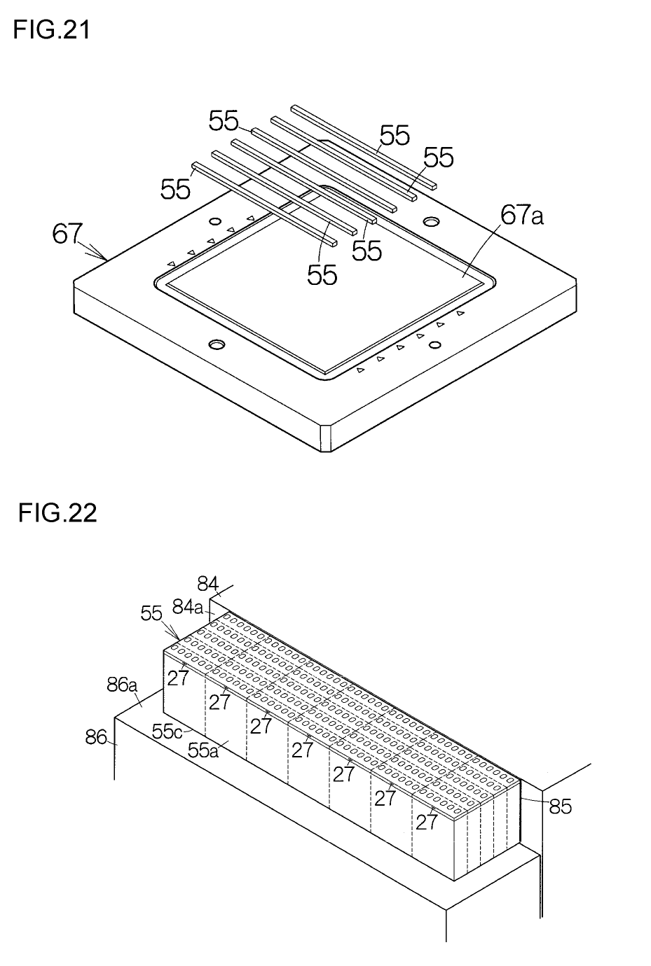

After that, as shown in FIG. 21, each bar 55 is removed from the supporting jig 67. Upon the removal, the supporting jig 67 is heated. The adhesive is softened under heating. In this way, the bar 55 is removed from the holding surface 67a of the supporting jig 67.

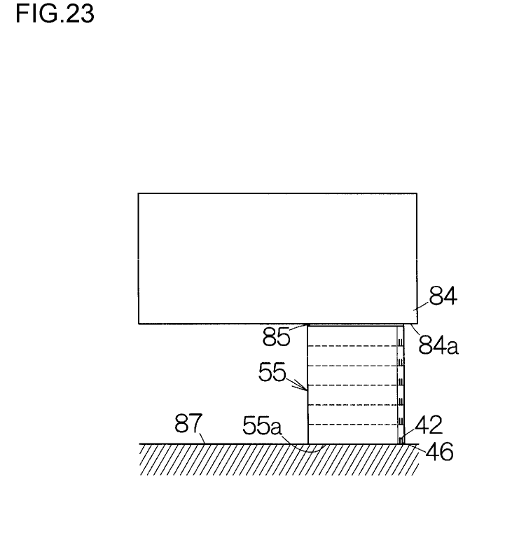

After that, as shown in FIG. 22, the bars 55 are independently bonded to a processing jig 84 for lapping processing. Upon bonding each bar 55, the other sectional surface (opposite to the sectional surface 55a) of each bar 55 is held on a bonding surface 84a of the processing jig 84. The bonding surface 84a is applied with a thermoplastic adhesive 85, for example. The processing jig 84 is heated. A fluidity of the thermoplastic adhesive 85 is kept.

At this time, it is necessary to precisely keep the sectional surface 55a used as the medium opposing surface 28 in parallel to the bonding surface 84a of the processing jig 84. A positioning jig 86 is used to keep the surfaces in parallel to each other. A surface 86a orthogonal to the bonding surface 84a is defined in the positioning jig 86. The “surface corresponding to rear side” 55c of the bar 55 is pressed against the surface 86a of the positioning jig 86. The thermoplastic adhesive 85 is cooled while the surface is being pressed. The thermoplastic adhesive 85 is hardened.

As shown in FIG. 23, the sectional surface 55a of the bar 55 is pressed against a lapping plate 87. The lapping plate 87 rotates about a rotational axis. Thus, the sectional surface 55a of the bar 55 is subjected to lapping processing. The electromagnetic conversion element 27 is subjected to grinding processing. As described above, upon the grinding processing, a read signal is read from the read element 42 selected from the electromagnetic conversion elements 27. The dimensions of the read element 42 are adjusted to a prescribed value based on the read signal. At this time, the sectional surface 55a of the bar 55 is precisely kept in parallel to the bonding surface 84a of the processing jig 84, so a grinding amount of the read element 42 is the same as that of the write element 46. The dimensions of the write element 46 can be similarly adjusted to a prescribed value.

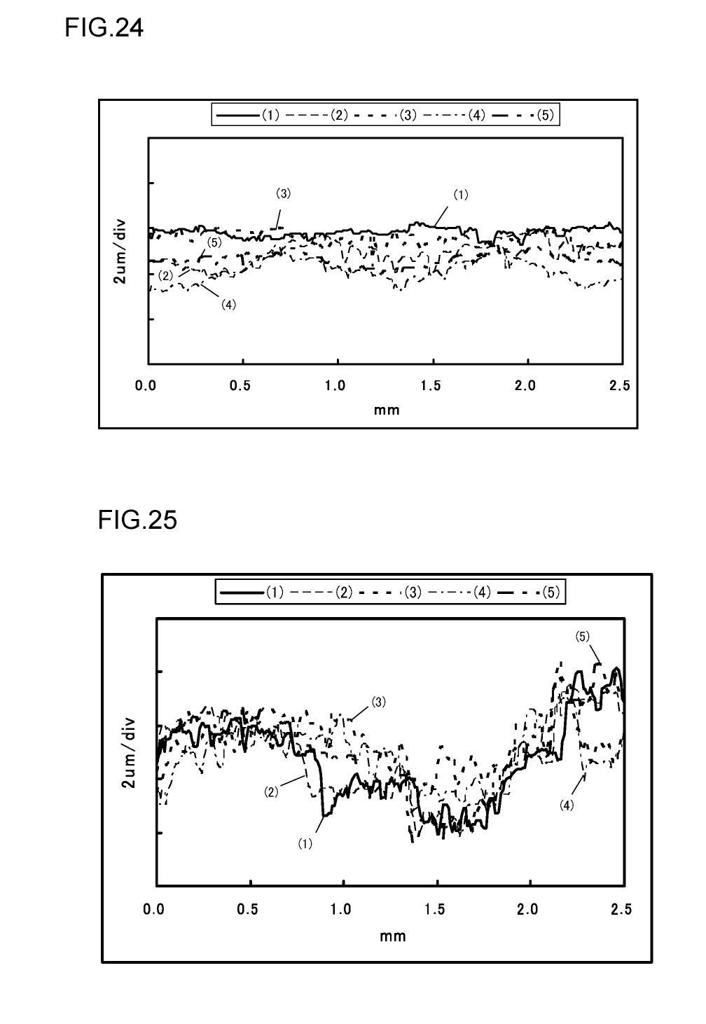

The inventors of the present technique have examined an effect of the grinding processing. The grind wheel 82 rotates about the rotational axis 83 extending in the longitudinal direction of the bar 55 as well as moves in the transverse direction of the bar 55. As a result, as shown from (1) to (5) in FIG. 24, the uneven surface is reduced. The angle between the bonding surface 84a and the sectional surface 55a of the bar 55 in the transverse direction can be suppressed to an angular accuracy of about ±2 degrees. The inventors of the present technique have examined grinding processing of Comparative Example. In Comparative Example, the grind wheel is rotated about a rotational axis extending in the transverse direction of the bar 55 as well as moves in the longitudinal direction of the bar 55. As a result, as shown from (1) to (5) in FIG. 25, surface roughness was confirmed to be about three times as large as the bar 55 subjected to the above grinding processing. The angle between the bonding surface 84a and the sectional surface 55a of the bar 55 in the transverse direction was suppressed to an angular accuracy of about ±0.1 degrees. In FIGS. 24 and 25, the vertical axis is graduated in 2 [μm] increments.

According to this manufacturing method, roughness of a surface-corresponding-to-rear-side of the bar 55 is reduced. By suppressing such roughness, the read element 42 and the write element 46 out of the electromagnetic conversion element 27 can be obtained with high dimensional accuracy. This manufacturing method considerably contributes to reduction of a dimension error in the electromagnetic conversion element 27, in particular, the write element 46.

What is claimed is:

1. A manufacturing method for a magnetic head slider, comprising the steps of:
(a) cutting a bar from a wafer having head elements arrayed thereon along sectional surfaces parallel to each other and orthogonal to a wafer surface, with one sectional surface being set as a medium opposing surface of the head slider; and
(b) performing grinding processing for grinding a surface-corresponding-to-rear-side corresponding to a wafer rear surface by a grinding surface rubbed in a transverse direction of the bar.

2. The manufacturing method for a magnetic head slider according to claim 1, wherein the grinding surface is formed around a grind wheel that rotates about a rotational axis extending in a longitudinal direction of the bar.

3. The manufacturing method for a magnetic head slider according to claim 2, further comprising:
(c) applying an adhesive to a flat holding surface defined on a supporting jig;
(d) setting a flat temporary holding surface opposite to the holding surface, with the flat temporary holding surface supporting the surface-corresponding-to-rear-side of the bar on a temporary fixture, to bring the bar into contact with the adhesive applied to the holding surface on a surface-corresponding-to-front-side corresponding to a wafer front surface and defined on a bar; and
(e) changing a posture of the temporary fixture with respect to the holding surface to adjust a posture of the surface-corresponding-to-rear-side with respect to the holding surface,
the step (c) and the step (d) and the step (e) being executed prior to the grinding processing.

4. The manufacturing method for a magnetic head slider according to claim 3, wherein the temporary fixture supports a plurality of the bars arranged in parallel with a predetermined interval.

5. The manufacturing method for a magnetic head slider according to claim 4, wherein upon the adjustment of the posture, an adjustment reflective surface is formed on the temporary fixture with a predetermined posture relative to the temporary holding surface.

6. The manufacturing method for a magnetic head slider according to claim 5, wherein at the time of bringing the bar into contact with the adhesive, a guide member for controlling displacement of the temporary fixture relative to the supporting jig in a vertical direction to the holding surface is coupled with the supporting jig.

7. The manufacturing method for a magnetic head slider according to claim 6, further comprising:
(f) setting the surface-corresponding-to-rear-side of the bar to overlap the temporary holding surface of the temporary fixture; and
(g) measuring a posture of the surface-corresponding-to-front-side of the bar with respect to the temporary holding surface, the step (f) and the step (g) being executed prior to the grinding processing.

8. The manufacturing method for a magnetic head slider according to claim 1, further comprising:
(h) performing polishing processing on the sectional surface set as the medium opposing surface to adjust dimensions of a read element among the head elements to a prescribed value.
